(19) United States
(12) Patent Application Publication
(10) Pub. No.: US 2025/0372319 A1
(43) Pub. Date: Dec. 4, 2025

(54) ELECTRICAL DEVICE WITH SWITCH PANEL

(71) Applicant: Zhuhai Shengchang Electronics Co., Ltd., Zhuhai (CN)

(72) Inventors: Jialong HU, Zhuhai (CN); Dehua ZHENG, Zhuhai (CN)

(73) Assignee: Zhuhai Shengchang Electronics Co., Ltd., Zhuhai (CN)

(21) Appl. No.: 18/753,153

(22) Filed: Jun. 25, 2024

(30) Foreign Application Priority Data
May 28, 2024 (CN) 202421188171.7

(51) Int. Cl. H01H 13/14; H01H 13/10

(52) U.S. Cl. CPC H01H 13/14; H01H 13/10

(57) ABSTRACT

An electrical device with a switch panel includes a key component, a mounting base and a switch component. The key component includes a key member and a supporting base, the key member includes a pressing body, the pressing body is provided with a pressing portion, and the key body is rotatably connected to the supporting base; the mounting base is provided on one side of the supporting base away from a key body, one of the mounting base and the supporting base is provided with a connecting hole, the other is provided with a connecting post, thereby the mounting base is non-detachably connected to the supporting base; the switch component is installed on the mounting base, and the key member moves toward or away from the switch component in response to the pressing of the pressing portion, thereby switching a switch state of the switch component.

### CROSS-REFERENCE TO RELATED APPLICATIONS

This application claims priority to Chinese Patent Application No. 202421188171.7, filed on May 28, 2024, the content of which is incorporated herein by reference in its entirety.

### TECHNICAL FIELD

The present disclosure herein relates to the technical field of press switches, and in particular to an electrical device with a switch panel.

### BACKGROUND

The key component and mounting base of current electrical device with a switch panel are usually detachable. The detachable connection method may cause misalignment between product components after reinstallation, resulting in product failure. The detachable connection method may also affect the safety of the product.

### SUMMARY

In order to overcome the shortcomings of the prior art, the purpose of the present disclosure is to provide an electrical device with a switch panel that is beneficial to reducing product failure and improving product use safety.

In order to solve the above problems, the technical solutions adopted by the present disclosure are as follows.

An electrical device with a switch panel comprises:
a key component, wherein the key component includes a key member and a supporting base, the key member includes a pressing body, the pressing body is provided with a pressing portion, and the key body is rotatably connected to the supporting base;
a mounting base, wherein the mounting base is provided on one side of the supporting base away from a key body, one of the mounting base and the supporting base is provided with a connecting hole, the other is provided with a connecting post, the connecting post is fixed in the connecting hole, thereby the mounting base is non-detachably connected to the supporting base; and
a switch component, wherein the switch component is installed on the mounting base, and the key member moves toward or away from the switch component in response to the pressing of the pressing portion, thereby switching a switch state of the switch component.

In some possible embodiments, the electrical device further comprises:
a junction box, wherein the junction box is provided on one side of the mounting base away from the key component, the junction box and the mounting base together form a cavity, and the junction box is provided with at least two ports; and
an isolation piece, wherein the isolation piece is installed on the mounting base, and the isolation piece is arranged in the cavity, whereby the cavity is divided into different sections; and
the mounting base is provided with at least two terminals, at least two of the terminals are exposed in different sections, and the port is used for inserting a cable to electrically connect the terminals.

In some possible embodiments, one of the supporting base and the mounting base is provided with a clamping hook, the other is provided with a clamping hole, the clamping hook comprises a connected elastic arm and a hook portion, the elastic arm passes through the clamping hole, and the hook portion is abutted against an edge of the clamping hole, whereby the clamping hook is detachably installed in the clamping hole.

In some possible embodiments, the supporting base includes:
a base body, wherein the base body is non-detachably connected to the mounting base, and an end surface of the base body away from the mounting base is recessed to form a first groove; and
two first connecting bases are arranged at intervals, and the first connecting bases are provided on a bottom wall of the first groove;
the key body includes:
a key plate, wherein the key plate is arranged in the first groove, and the key plate is provided with the pressing portion; and
two second connecting bases are arranged at intervals, the second connecting bases are fixed on an end surface of the key plate opposite to the mounting base, one of the first connecting base and the second connecting base is provided with a rotating shaft, the other is provided with a mounting hole, and the rotating shaft is rotatably arranged in the mounting hole.

In some possible embodiments, the key plate is recessed relative to an end surface of the mounting base to form a second groove, and the second connecting base is fixed to a bottom wall of the second groove.

In some possible embodiments, the mounting base includes:
a fixing plate, wherein the fixing plate is non-detachably connected to the supporting base; and
a housing, wherein the housing is detachably connected to the fixing plate, the housing is arranged on one side of the fixing plate away from the key component, and the housing and the fixing plate jointly form an accommodating cavity; and
the switch component is installed in the accommodating cavity, and the key member is arranged pass through the fixing plate.

In some possible embodiments, the fixing plate is provided with the connecting hole, a projection of the connecting hole is into the accommodating cavity, and the supporting base is provided with the connecting post.

In some possible embodiments, the fixing plate is provided with the clamping hole, a projection of the clamping hole is into the accommodating cavity, and the elastic arm is provided on the supporting base.

In some possible embodiments, the housing is provided with an opening hole, and the hook portion is exposed in the opening hole.

In some possible embodiments, the fixing plate and the housing are both provided with a threaded hole, and a screw is installed in the threaded hole of both the fixing plate and the housing.

In some possible embodiments, the supporting base is provided with a mounting cavity inside, and the key component further includes:
a first limiting piece, wherein the first limiting piece is installed on the key member, the first limiting piece is provided with two limiting holes, and the two limiting holes are spaced apart along an arrangement direction of the mounting base and the supporting base;
a second limiting piece, wherein the second limiting piece is provided with a first limiting portion and a second limiting portion, the second limiting portion is protruded on a circumferential direction of the first limiting portion; and
a reset piece, wherein the reset piece and the second limiting portion are both arranged in the mounting cavity, and the reset piece is used to push the second limiting portion to move, whereby the first limiting portion passes through the mounting cavity, and the first limiting portion is used to be reciprocally installed in the two limiting holes, whereby the key member maintains a rotating state.

In some possible embodiments, the key member further includes:
a triggering portion, wherein the triggering portion is fixed on the pressing portion to pass through the supporting base, the triggering portion moves toward or away from the switch component in response to the pressing of the pressing portion, thereby switching the switch state of the switch component.

Compared with the prior art, the beneficial effects of the present disclosure are: according to the present disclosure, the supporting base of the key component is fixed to the mounting base through a non-detachable connection between the connecting post and the connecting hole, which solves the product failure and product use safety problems caused by the detachability between the key component and the mounting base in the prior art. Therefore, the electrical device with the switch panel provided by the present disclosure is beneficial to reducing product failure and improving product use safety.

The present disclosure will be further described in detail below in conjunction with the accompanying drawings and specific embodiments.

### BRIEF DESCRIPTION OF THE DRAWINGS

FIG. 1 is a partially exploded structure schematic diagram of an electrical device with a switch panel provided by an embodiment of the present disclosure.

FIG. 2 is a partial structure schematic diagram of an electrical device shown in FIG. 1.

FIG. 3 is a structure schematic diagram of FIG. 2 from another perspective.

FIG. 4 is a cross-sectional view along A-A in FIG. 2.

FIG. 5 is a cross-sectional view along B-B in FIG. 2.

FIG. 6 is a cross-sectional view along C-C in FIG. 2.

FIG. 7 is a structure schematic diagram of a key member.

FIG. 8 is a structure schematic diagram of a supporting base, clamping hook and connecting post.

FIG. 9 is a structure schematic diagram of FIG. 8 from another perspective.

### DETAILED DESCRIPTION OF THE EMBODIMENTS

The technical solutions in the embodiments of the present disclosure will be clearly and completely described below with reference to the accompanying drawings in the embodiments of the present disclosure. Obviously, the described embodiments are only some of the embodiments of the present disclosure, rather than all of the embodiments. Based on the embodiments in the present disclosure, all other embodiments obtained by those ordinary skilled in the art without creative efforts fall within the scope of protection of the present disclosure.

The terms “first”, “second”, etc. in the description and claims of the present disclosure and the above-mentioned drawings are used to distinguish different objects, rather than describing a specific sequence. Furthermore, the terms “comprise” and “provided with” and any variations thereof are intended to cover non-exclusive inclusion. It should be noted that when an element is referred to as being “fixed” to another element, it can be directly on the other element or intervening elements may also be present. When an element is referred to as being “connected to” another element, it can be directly connected to the other element or intervening elements may also be present. When an element is referred to as being “arranged on” another element, it can be arranged on the other element or intervening elements may also be present.

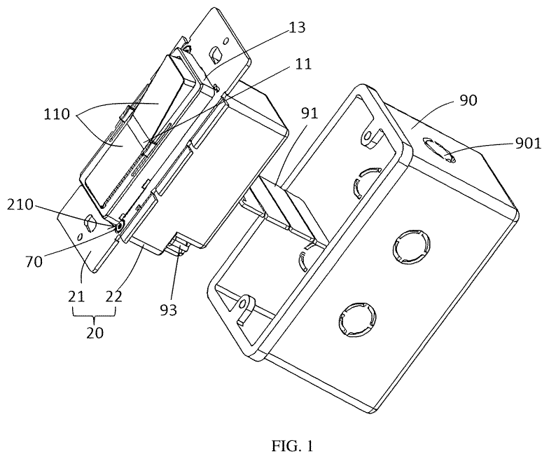

Referring to FIGS. 1 to 6, an embodiment of the present disclosure provides an electrical device with a switch panel, hereinafter referred to as the electrical device 100. For example, the electrical device 100 may be a dimmer or an electronic doorbell. Specifically, the electrical device 100 comprises a key component 10, a mounting base 20 and a switch component 30. The key component 10 includes a key body 11 and a supporting base 13, the key member includes a key body 11, and the key body 11 is provided with a pressing portion 110. For example, the key body 11 may be provided with two pressing portions 110. The key body 11 is rotatably connected to the supporting base 13. For example, both the key member and the supporting base 13 can be plastic portions. The mounting base 20 is provided on one side of the supporting base 13 away from a key body 11, one of the mounting base 20 and the supporting base 13 is provided with a connecting hole 201, the other is provided with a connecting post 40, the connecting post 40 is fixed in the connecting hole 201, thereby the mounting base 20 is non-detachably connected to the supporting base 13. For example, after the connecting post 40 is arranged in the connecting hole 201, the connecting post 40 can be fixed in the connecting hole 201 by hot melt welding, cold expansion or ultrasonic welding; or the diameter of the connecting post 40 is larger than the diameter of the connecting hole 201, the connecting post 40 is deformed and shrunk and inserted into the connecting hole 201 and then deformed and recovered, making the connecting post 40 and the connecting hole 201 non-detachable. For example, the connecting hole 201 may be a through hole. The switch component 30 is installed on the mounting base 20, and the key member moves toward or away from the switch component 30 in response to the pressing of the pressing portion 110, thereby switching a switch state of the switch component 30.

According to the present disclosure, the supporting base 13 of the key component 10 is fixed to the mounting base 20 through a non-detachable connection between the connecting post 40 and the connecting hole 201, which solves the product failure and product use safety problems caused by the detachability between the key component 10 and the mounting base 20 in the prior art. Therefore, the electrical device 100 with the switch panel provided by the present disclosure is beneficial to reducing product failure and improving product use safety.

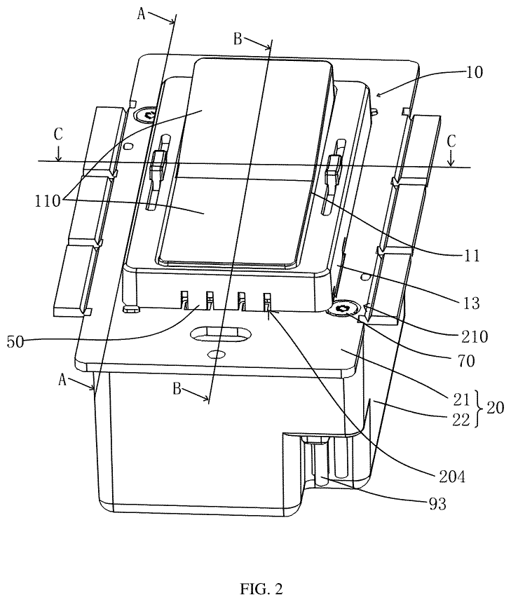

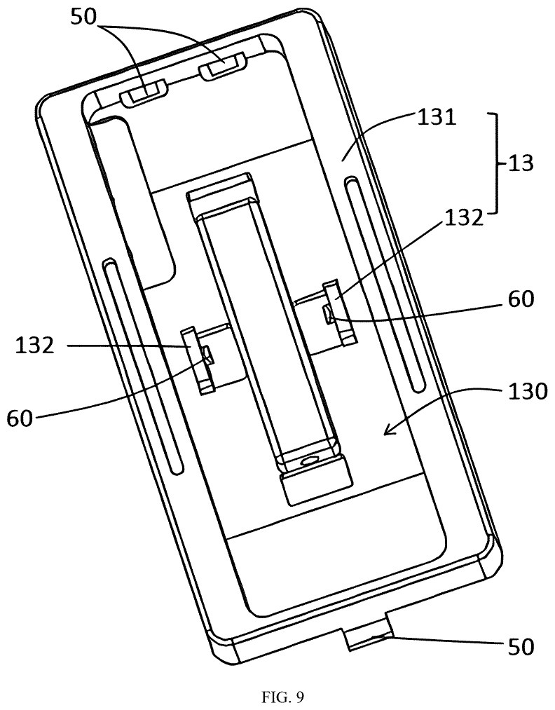

In some embodiments, referring to FIGS. 2 and 8, one of the supporting base 13 and the mounting base 20 is provided with a clamping hook 50, the other is provided with a clamping hole 204, the clamping hook 50 comprises a connected elastic arm 51 and a hook portion 52, the elastic arm 51 passes through the clamping hole 204, and the hook portion 52 is abutted against an edge of the clamping hole 204, whereby the clamping hook 50 is detachably installed in the clamping hole 204. In this embodiment, the number of clamping hooks 50 may be three, and the three clamping hooks 50 are divided into two groups arranged at intervals. The two sets of clamping hooks 50 can be arranged along the arrangement direction of the two pressing portions 110, and the two pressing portions 110 can be arranged between the two sets of clamping hooks 50. The cooperation between the clamping hook 50 and the clamping hole 204 is conducive to improving the preliminary positioning stability of the supporting base 13 and the mounting base 20, thereby improving the assembly convenience of the electrical device 100. During specific installation, the clamping hook 50 and the clamping hole 204 can be assembled, the connecting post 40 and the connecting hole 201 are installed, and then the connecting post 40 and the connecting hole 201 can be fixed by hot melt welding, cold expansion or ultrasonic welding.

In some embodiments, the key member further includes a triggering portion 12, the triggering portion 12 is fixed on the pressing portion 110 to pass through the supporting base 13, the triggering portion 12 moves toward or away from the switch component 30 in response to the pressing of the pressing portion 110, thereby switching the switch state of the switch component 30.

In some embodiments, continuing to refer to FIGS. 2 to 6, the mounting base 20 includes a fixing plate 21 and a housing 22, the fixing plate 21 is non-detachably connected to the supporting base 13, that is, one of the connecting hole 201 and the connecting post 40 is arranged on the fixing plate 21. The housing 22 is detachably connected to the fixing plate 21, the housing 22 is arranged on one side of the fixing plate 21 away from the key component 10, and the housing 22 and the fixing plate 21 jointly form an accommodating cavity 202; and the switch component 30 is installed in the accommodating cavity 202. For example, the switch component 30 can be installed on one side of the fixing plate 21 away from the key component 10 through screws or buckles, and the key member is arranged pass through the fixing plate 21. The switch component 30 can be installed in the accommodating cavity 202, which is beneficial to improving the protection of the switch component 30.

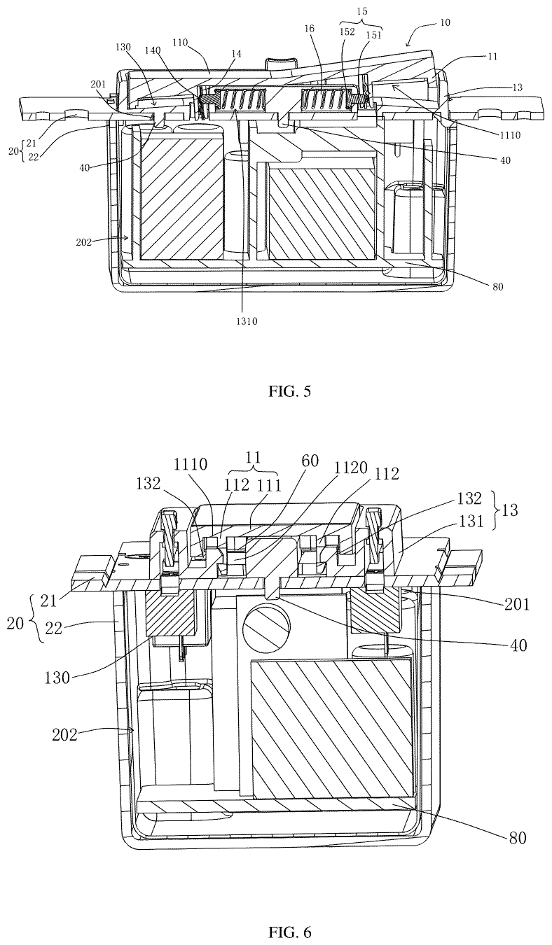

In some embodiments, referring to FIG. 5, the fixing plate 21 is provided with the connecting hole 201, a projection of the connecting hole 201 is into the accommodating cavity 202, and the supporting base 13 is provided with the connecting post 40. The positions of the connecting hole 201 and the connecting post 40 facilitates hiding the connecting hole 201 and the connecting post 40, thereby improving the simplicity of the appearance of the electrical device 100 and reducing the possibility of dust accumulation at the connecting hole 201.

In some embodiments, the fixing plate 21 is provided with the clamping hole 204, a projection of the clamping hole 204 is into the accommodating cavity 202, the elastic arm 51 is provided on the supporting base 13, and the positions of the clamping hook 50 and the clamping hole 204 are conducive to improving the simplicity of the appearance of the electrical device 100.

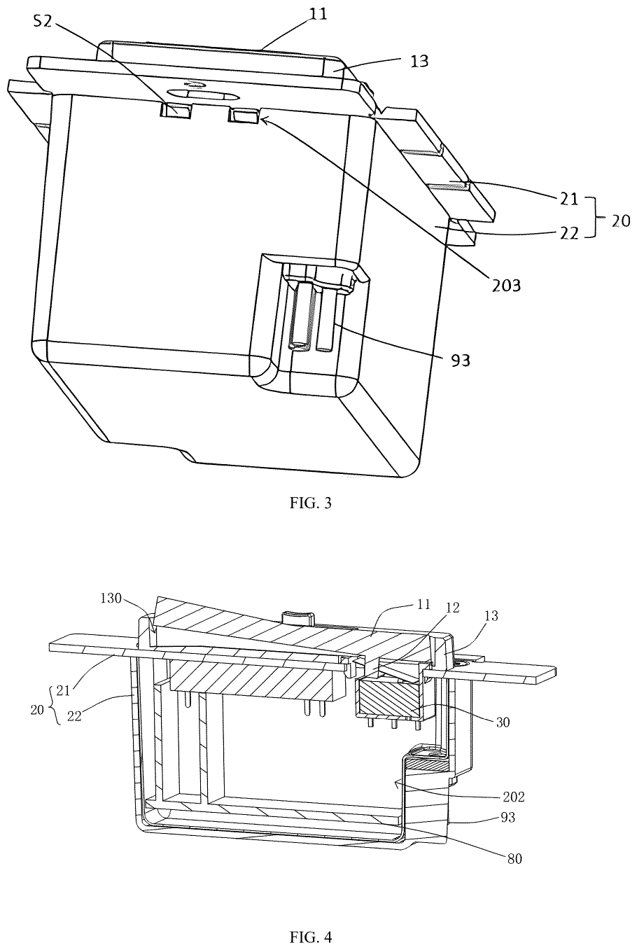

In some embodiments, referring to FIG. 3, the housing 22 is provided with an opening hole 203, the hook portion 52 is exposed in the opening hole 203, and the opening hole 203 facilitates the user to press the hook portion 52 to deform the elastic arm 51 of the clamping hook 50, thereby facilitating the clamping hook 50 to detach from the clamping hole 204. Therefore, the opening hole 203 is conducive to improving the convenience of disassembly of the clamping hook 50.

In some embodiments, referring to FIG. 2, the fixing plate 21 and the housing 22 are both provided with a threaded hole 210, and a screw 70 is installed in the threaded hole 210 of both the fixing plate 21 and the housing 22, thereby achieving the detachable connection between the fixing plate 21 and the housing 22. The connection method of screws 70 cooperate with the threaded holes 210 is conducive to simplifying the structure of electrical device 100.

In other embodiments, the fixing plate 21 and the housing 22 can be detachably connected by snapping.

In other embodiments, the switch component 30 may be installed on one side of the fixing plate 21 away from or opposite to the key component 10, and the mounting base 20 may not include a housing 22.

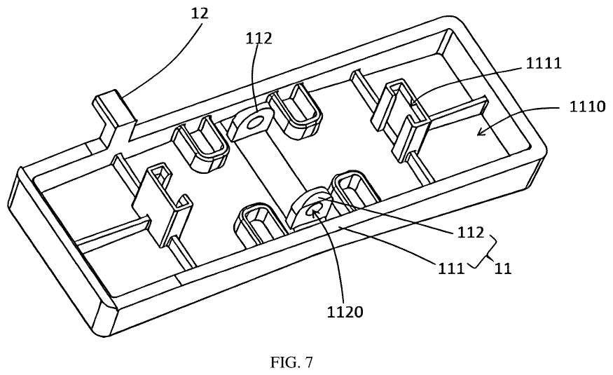

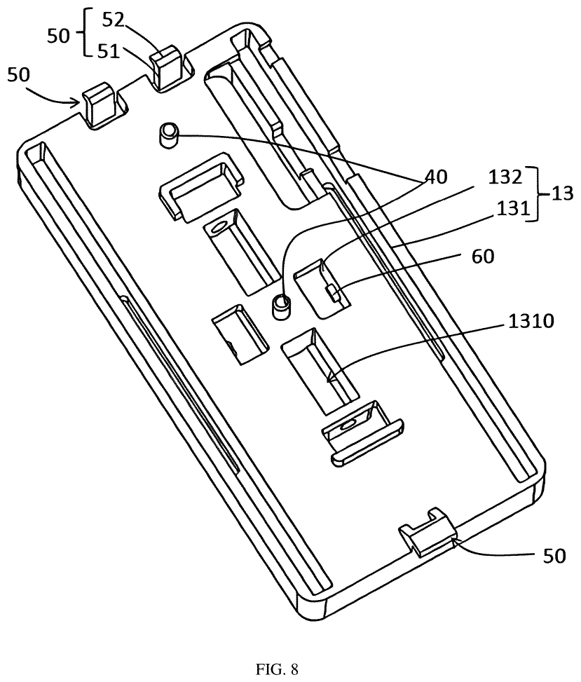

In some embodiments, referring to FIGS. 5-6, 8 and 9, the supporting base 13 includes a base body 131 and two first connecting bases 132 arranged at intervals, and the base body 131 is non-detachably connected to the mounting base 20, that is, one of the connecting post 40 and the connecting hole 201 is arranged in the base body 131. In this embodiment, the connecting post 40 is arranged on the base body 131. An end surface of the base body 131 away from the mounting base 20 is recessed to form a first groove 130, and the first connecting bases 132 are provided on a bottom wall of the first groove 130. Referring to FIG. 6, the key body 11 includes a key plate 111 and two second connecting bases 112 arranged at intervals, the key plate 111 is arranged in the first groove 130, and the key plate 111 is provided with the pressing portion 110; the second connecting bases 112 are fixed on an end surface of the key plate 111 opposite to the mounting base 20, one of the first connecting base 132 and the second connecting base 112 is provided with a rotating shaft 60, the other is provided with a mounting hole 1120, and the rotating shaft 60 is rotatably arranged in the mounting hole 1120, so that the key body 11 is rotatably connected to the supporting base 13. For example, the pressing portion 110 may be arranged perpendicularly to the arrangement direction of the two second connecting bases 112.

In this embodiment, the rotating shaft 60 is provided on the first connecting base 132, the rotating shaft 60 is protruded on the first connecting base 132 relative to another first connecting base 132, and the mounting hole 1120 is provided on the second connecting base 112. For example, the mounting hole 1120 may be a through hole.

The structural arrangement of the supporting base 13 and the key body 11 is conducive to reducing the integrated volume of the key component 10 and improving the simplicity of the appearance of the electrical device 100 with the switch panel.

In some embodiments, the key plate 111 is recessed relative to an end surface of the mounting base 20 to form a second groove 1110, and the second connecting base 112 is fixed to a bottom wall of the second groove 1110. The structural arrangement of the key plate 111 is conducive to further reducing the integrated volume of the key component 10.

In some embodiments, the supporting base 13 is provided with a mounting cavity 1310 inside. In this embodiment, the mounting cavity 1310 is arranged on the base body 131. The key component 10 also includes a first limiting piece 14 (two first limiting pieces 14 are shown in the Figure), a second limiting piece 15 (two second limiting pieces 15 are shown in the Figure) and a reset piece 16 (two reset pieces 16 are shown in the Figure). The first limiting piece 14 is installed on the key member. For example, the key plate 111 of the key body 11 can be provided with a mounting groove 1111 at one end relative to the mounting base 20, the opening of the mounting groove 1111 is arranged relative to the mounting base 20, the first limiting piece 14 can be abutted and limited in the mounting groove 1111, the first limiting piece 14 is provided with two limiting holes 140, and the two limiting holes 140 are arranged at intervals along the arrangement direction of the mounting base 20 and the supporting base 13. For example, the limiting hole 140 may be a blind hole. The second limiting piece 15 is provided with a first limiting portion 151 and a second limiting portion 152, the second limiting portion 152 is protruded on a circumferential direction of the first limiting portion 151. The reset piece 16 and the second limiting portion 152 are both arranged in the mounting cavity 1310, and the reset piece 16 is used to push the second limiting portion 152 to move, whereby the first limiting portion 151 passes through the mounting cavity 1310, and the first limiting portion 1310 is used to be reciprocally installed in the two limiting holes 152, whereby the key member maintains a rotating state. For example, the reset piece 16 may be a telescopic spring. For example, the mounting cavity 1310 may be formed by a recessed end surface of the base body 131 relative to the mounting base 20, thereby facilitating the replacement of the second limiting piece 15 and the reset piece 16, which in turn improves the service life of the electrical device 100. The second limiting portion 152 is protruded on a circumferential direction of the first limiting portion 151 to prevent the second limiting piece 15 from being detached from the mounting cavity 1310.

In other embodiments, the first limiting piece 14 can be installed by welding, bonding or screwing.

It can be understood that maintaining the rotation state of the key member via the first limiting piece 14, the second limiting piece 15 and the reset piece 16 is only a specific method of the present disclosure. In other embodiments, the key member can be maintained via other structures remain in rotation.

In some embodiments, the electrical device 100 with the switch panel may further include a circuit component 80, the circuit component 80 may be arranged in the accommodating cavity 202, the circuit component 80 may be electrically connected to the switch component 30, and the on/off conversion of the circuit component 80 can be achieved through the state conversion of the switch component 30.

In some embodiments, referring to FIG. 1, the electrical device 100 further includes a junction box 90 and an isolation piece 91, the junction box 90 is provided on one side of the mounting base 20 away from the key component 10, and the junction box 90 and the mounting base 20 together form a cavity. In this embodiment, the junction box 90 and the fixing plate 21 of the mounting base 20 together form the cavity, and the junction box 90 is provided with at least two ports 901 (two ports 901 are shown in the Figure). For example, the ports can be an opening hole or a knock-out hole. The isolation piece 91 is installed on the mounting base 20. For example, the isolation piece 91 can be installed on the housing 22 of the mounting base 20 by snapping, welding or bonding. The isolation piece 91 is arranged in the cavity, whereby the cavity is divided into different sections. The mounting base 20 is provided with at least two terminals 93 (two terminals 93 are shown in the Figure). In this embodiment, the terminals 93 are provided on the housing 22, at least two terminals 93 are exposed to different sections, and port 901 is used for cable insertion to electrically connect the terminal 93.

The above-mentioned embodiments are only preferred embodiments of the present disclosure and cannot be used to limit the scope of protection of the present disclosure. Any non-substantive changes and substitutions made by those skilled in the art on the basis of the present disclosure shall belong to the scope of protection claimed by the present disclosure.

What is claimed is:

1. An electrical device with a switch panel, comprising:
a key component, wherein the key component comprises a key member and a supporting base, the key member comprises a pressing body, the pressing body is provided with a pressing portion, and the key body is rotatably connected to the supporting base;
a mounting base, wherein the mounting base is provided on one side of the supporting base away from a key body, one of the mounting base and the supporting base is provided with a connecting hole, the other is provided with a connecting post, the connecting post is fixed in the connecting hole, thereby the mounting base is non-detachably connected to the supporting base; and
a switch component, wherein the switch component is installed on the mounting base, and the key member moves toward or away from the switch component in response to the pressing of the pressing portion, thereby switching a switch state of the switch component.

2. The electrical device with the switch panel according to claim 1, wherein the electrical device further comprises:
a junction box, wherein the junction box is provided on one side of the mounting base away from the key component, the junction box and the mounting base together form a cavity, and the junction box is provided with at least two ports; and
an isolation piece, wherein the isolation piece is installed on the mounting base, and the isolation piece is arranged in the cavity, whereby the cavity is divided into different sections;
wherein the mounting base is provided with at least two terminals, at least two of the terminals are exposed in different sections, and the port is used for inserting a cable to electrically connect the terminals.

3. The electrical device with the switch panel according to claim 1, wherein one of the supporting base and the mounting base is provided with a clamping hook, the other is provided with a clamping hole, the clamping hook comprises a connected elastic arm and a hook portion, the elastic arm passes through the clamping hole, and the hook portion is abutted against an edge of the clamping hole, whereby the clamping hook is detachably installed in the clamping hole.

4. The electrical device with the switch panel according to claim 1, wherein the supporting base comprises:
a base body, wherein the base body is non-detachably connected to the mounting base, and an end surface of the base body away from the mounting base is recessed to form a first groove;
wherein two first connecting bases are arranged at intervals, and the first connecting bases are provided on a bottom wall of the first groove;
the key body comprises:
a key plate, wherein the key plate is arranged in the first groove, and the key plate is provided with the pressing portion;
wherein two second connecting bases are arranged at intervals, the second connecting bases are fixed on an end surface of the key plate opposite to the mounting base, one of the first connecting base and the second connecting base is provided with a rotating shaft, the other is provided with a mounting hole, and the rotating shaft is rotatably arranged in the mounting hole.

5. The electrical device with the switch panel according to claim 4, wherein the key plate is recessed relative to an end surface of the mounting base to form a second groove, and the second connecting base is fixed to a bottom wall of the second groove.

6. The electrical device with the switch panel according to claim 3, wherein the mounting base comprises:
a fixing plate, wherein the fixing plate is non-detachably connected to the supporting base; and
a housing, wherein the housing is detachably connected to the fixing plate, the housing is arranged on one side of the fixing plate away from the key component, and the housing and the fixing plate jointly form an accommodating cavity;
wherein the switch component is installed in the accommodating cavity, and the key member is arranged pass through the fixing plate.

7. The electrical device with the switch panel according to claim 6, wherein the fixing plate is provided with the connecting hole, a projection of the connecting hole is into the accommodating cavity, and the supporting base is provided with the connecting post.

8. The electrical device with the switch panel according to claim 6, wherein the fixing plate is provided with the clamping hole, a projection of the clamping hole is into the accommodating cavity, and the elastic arm is provided on the supporting base.

9. The electrical device with the switch panel according to claim 8, wherein the housing is provided with an opening hole, and the hook portion is exposed in the opening hole.

10. The electrical device with the switch panel according to claim 6, wherein the fixing plate and the housing are both provided with a threaded hole, and a screw is installed in the threaded hole of both the fixing plate and the housing.

11. The electrical device with the switch panel according to claim 1, wherein the supporting base is provided with a mounting cavity inside, and the key component further comprises:
a first limiting piece, wherein the first limiting piece is installed on the key member, the first limiting piece is provided with two limiting holes, and the two limiting holes are spaced apart along an arrangement direction of the mounting base and the supporting base;
a second limiting piece, wherein the second limiting piece is provided with a first limiting portion and a second limiting portion, the second limiting portion is protruded on a circumferential direction of the first limiting portion; and
a reset piece, wherein the reset piece and the second limiting portion are both arranged in the mounting cavity, and the reset piece is used to push the second limiting portion to move, whereby the first limiting portion passes through the mounting cavity, and the first limiting portion is used to be reciprocally installed in the two limiting holes, whereby the key member maintains a rotating state.

12. The electrical device with the switch panel according to claim 1, wherein the key member further comprises:
a triggering portion, wherein the triggering portion is fixed on the pressing portion to pass through the supporting base, the triggering portion moves toward or away from the switch component in response to the pressing of the pressing portion, thereby switching the switch state of the switch component.
